(19) United States
(12) Patent Application Publication
(10) Pub. No.: US 2025/0104648 A1
(43) Pub. Date: Mar. 27, 2025

(54) GATE DRIVER AND DISPLAY DEVICE INCLUDING THE SAME

(71) Applicant: Samsung Display Co., LTD., Yongin-si (KR)

(72) Inventor: JUNGHWAN HWANG, Yongin-si (KR)

(21) Appl. No.: 18/740,299

(22) Filed: Jun. 11, 2024

(30) Foreign Application Priority Data
Sep. 26, 2023 (KR) 10-2023-0129883

(51) Int. Cl. G09G 3/3266; G09G 3/3291

(52) U.S. Cl. CPC G09G 3/3266; G09G 3/3291; G09G 2310/08; G09G 2330/021

(57) ABSTRACT

A gate driver includes at least one stage including: a first transistor including a control electrode receiving a first clock signal, a first electrode receiving a previous stage gate signal, and a second electrode connected to a first node; a third transistor including a control electrode directly receiving the first clock signal, a first electrode receiving a first power voltage, and a second electrode connected to a third node; a fourth transistor including a control electrode connected to a second node, a first electrode receiving a second clock signal different from the first clock signal, and a second electrode connected to the third node; and a first capacitor including a first electrode connected to the second node and a second electrode connected to the third node, wherein the least one stage outputs a voltage of the third node as a gate signal.

### CROSS-REFERENCE TO RELATED APPLICATION

The present application claims priority to and the benefit of Korean Patent Application No. 10-2023-0129883, filed on Sep. 26, 2023, in the Korean Intellectual Property Office, the entire disclosure of which is incorporated herein by reference.

### BACKGROUND

### 1. Field

Aspects of some embodiments of the present disclosure relate to a display device.

### 2. Description of the Related Art

Generally, a display device includes a display panel and a display panel driver for driving the display panel. The display panel includes a plurality of gate lines, a plurality of data lines and a plurality of pixels. The display panel driver may include a gate driver providing gate signals to the gate lines and a data driver providing data voltages to the data lines.

Generally, the gate driver may include a plurality of transistors and a plurality of capacitors, so that a bezel size of the display device may be relatively increased.

The above information disclosed in this Background section is only for enhancement of understanding of the background and therefore the information discussed in this Background section does not necessarily constitute prior art.

### SUMMARY

Aspects of some embodiments of the present disclosure relate to a display device. For example, aspects of some embodiments of the present disclosure relate to a gate driver and a display device including the gate driver.

Aspects of some embodiments include a gate driver with relatively improved integration.

Aspects of some embodiments may also include a display device including the gate driver.

According to some embodiments, a gate driver includes a plurality of stages. At least one stage of the plurality of stages includes a first transistor including a control electrode configured to directly receive a first clock signal, a first electrode configured to receive a previous stage gate signal and a second electrode connected to a first node, a third transistor including a control electrode configured to receive the first clock signal directly, a first electrode configured to receive a first power voltage and a second electrode connected to a third node, a fourth transistor including a control electrode connected to a second node, a first electrode configured to receive a second clock signal different from the first clock signal and a second electrode connected to the third node and a first capacitor including a first electrode connected to the second node and a second electrode connected to the third node. According to some embodiments, the least one stage outputs a voltage of the third node as a gate signal.

According to some embodiments, the least one stage may further include a second transistor including a control electrode configured to receive a second power voltage different from the first power voltage, a first electrode connected to the first node and a second electrode connected to the second node.

According to some embodiments, a ratio of a channel width to a channel length of the third transistor is different from a ratio of a channel width to a channel length of the fourth transistor.

According to some embodiments, a channel width of the third transistor may be narrower than a channel width of the fourth transistor.

According to some embodiments, the fourth transistor may be turned on based on the previous stage gate signal having an activation level in a first period.

According to some embodiments, in a second period subsequent to the first period, the first clock signal may have an inactivation level, the second clock signal may have an activation level and a voltage of the second node may be lower than a low voltage of the second clock signal.

According to some embodiments, in a third period subsequent to the second period, the first clock signal may have an activation level, the second clock signal may have an inactivation level and the gate signal has an inactivation level.

According to some embodiments, the least one stage may further include a second transistor including a control electrode configured to receive a second power voltage different from the first power voltage, a first electrode connected to the first node and a second electrode connected to the second node. According to some embodiments, a channel length of the first transistor may be longer than a channel length of the second transistor.

According to some embodiments, an activation level period of the first clock signal may be longer than an inactivation level period of the first clock signal. According to some embodiments, a phase of the second clock signal may be opposite to a phase of the first clock signal.

According to some embodiments, the least one stage may further include a first-second transistor connected in series with the first transistor. According to some embodiments, the first-second transistor may include a control electrode configured to receive the first clock signal, a first electrode connected to a fourth node and a second electrode connected to the first node.

According to some embodiments, a gate driver includes a plurality of stages. At least one stage of the stages includes a first transistor configured to apply a previous stage gate signal to a first node in response to a first clock signal, a second transistor connected between the first node and a second node, a third transistor configured to directly receive the first clock signal and configured to apply a first power voltage to a third node, a fourth transistor configured to apply a second clock signal different from the first clock signal to the third node in response to a voltage of the second node and a first capacitor connected between the second node and the third node. According to some embodiments, the least one stage outputs a voltage of the third node as a gate signal.

According to some embodiments, a ratio of a channel width to a channel length of the third transistor is different from a ratio of a channel width to a channel length of the fourth transistor.

According to some embodiments, a channel width of the third transistor may be narrower than a channel width of the fourth transistor.

According to some embodiments, a display device includes a display panel, a gate driver and a data driver. According to some embodiments, the gate driver outputs a gate signal to a gate line of the display panel. According to some embodiments, the data driver outputs a data voltage to a data line of the display panel. According to some embodiments, the gate driver includes a plurality of stages. According to some embodiments, at least one stage of the plurality of stages includes a first transistor including a control electrode configured to receive a first clock signal, a first electrode configured to receive start signal and a second electrode connected to a first node, a second transistor including a control electrode configured to receive a second power voltage, a first electrode connected to the first node and a second electrode connected to a second node, a third transistor including a control electrode configured to receive the first clock signal directly, a first electrode configured to receive a first power voltage different from the second power voltage and a second electrode connected to a third node, a fourth transistor including a control electrode connected to the second node, a first electrode configured to receive a second clock signal different from the first clock signal and a second electrode connected to the third node and a first capacitor including a first electrode connected to the second node and a second electrode connected to the third node. According to some embodiments, the least one stage outputs a voltage of the third node as the gate signal.

According to some embodiments, a ratio of a channel width to a channel length of the third transistor is different from a ratio of a channel width to a channel length of the fourth transistor.

According to some embodiments, a channel width of the third transistor may be narrower than a channel width of the fourth transistor.

According to some embodiments, the fourth transistor may be turned on based on the start signal having an activation level in a first period.

According to some embodiments, in a second period subsequent to the first period, the first clock signal may have an inactivation level, the second clock signal may have activation level, and a voltage of the second node may be lower than the second power voltage.

According to some embodiments, in a third period subsequent to the second period, the first clock signal may have an activation level, the second clock signal may have an inactivation level and the gate signal may have an inactivation level.

According to some embodiments, an activation level period of the first clock signal may be longer than an inactivation level period of the first clock signal. According to some embodiments, the second clock signal may have an inverted phase from the first clock signal.

In a gate driver and the display device according to some embodiments, an integration of the display device may be relatively improved and a bezel size of the display device become relatively smaller by including a smaller number of transistors and a smaller number of capacitors compared to an alternative gate driver.

Additionally, a ratio of the channel width (W) and channel length (L) of any one of the transistors included in the gate driver may be variable, so that the bezel size of the display device may become smaller.

### BRIEF DESCRIPTION OF THE DRAWINGS

The above and other features and characteristics of embodiments according to the present disclosure will become more apparent by describing in more detail aspects of some embodiments thereof with reference to the accompanying drawings, in which:

FIG. 1 is a block diagram illustrating a display device according to some embodiments.

FIG. 2 is a block diagram illustrating a gate driver included in display device of FIG. 1 according to some embodiments.

FIG. 3 is a circuit diagram illustrating a gate driver of FIG. 2 according to some embodiments.

FIG. 4 is a circuit diagram illustrating a pixel circuit included in a display device of FIG. 1 according to some embodiments.

FIG. 5 is a timing diagram illustrating a gate driver of FIG. 2 according to some embodiments.

FIG. 6 is a circuit diagram illustrating an operation of a gate driver of FIG. 2 in a first period according to some embodiments.

FIG. 7 is a circuit diagram illustrating an operation of a gate driver of FIG. 2 in a second period according to some embodiments.

FIG. 8 is a circuit diagram illustrating an operation of a gate driver of FIG. 2 in a third period according to some embodiments.

FIG. 9 is a circuit diagram illustrating a gate driver of FIG. 2 according to some embodiments.

FIG. 10 is a circuit diagram illustrating a gate driver of FIG. 2 according to some embodiments.

FIG. 11 is a circuit diagram illustrating a gate driver of FIG. 2 according to some embodiments.

FIG. 12 is a block diagram illustrating an electronic device according to some embodiments; and

FIG. 13 is a diagram illustrating an example in which the electronic device of FIG. 12 is implemented as a smart phone according to some embodiments.

### DETAILED DESCRIPTION

Hereinafter, aspects of some embodiments of the present disclosure will be described in more detail with reference to the accompanying drawings.

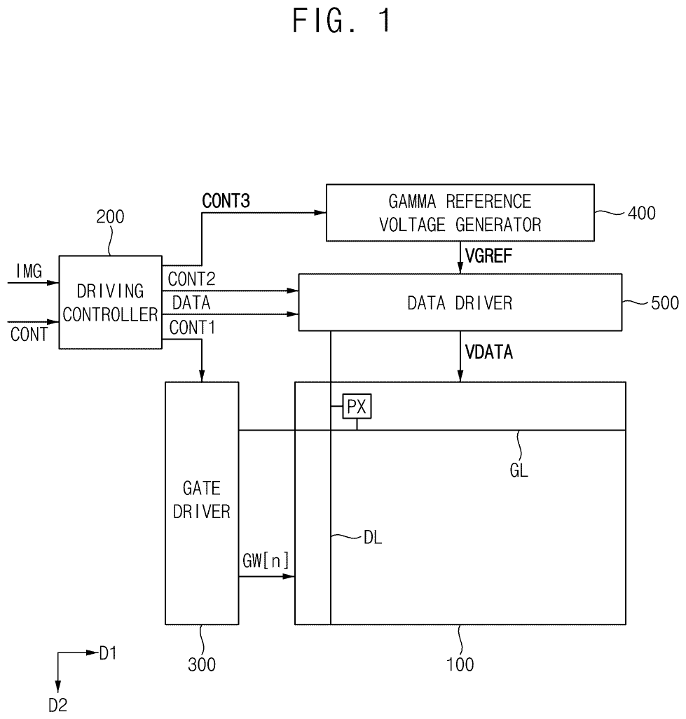

FIG. 1 is a block diagram illustrating a display device according to some embodiments.

Referring to FIG. 1, the display device includes a display panel 100 and a display panel driver. The display panel driver includes a driving controller 200, a gate driver 300, a gamma reference voltage generator 400 and a data driver 500.

For example, the driving controller 200 and the data driver 500 may be integrally formed (e.g., as a single component). For example, the driving controller 200, the gamma reference voltage generator 400, and the data driver 500 may be integrally formed (e.g., as a single component). A driving module including at least the driving controller 200 and the data driver 500 which are integrally formed may be referred to as a timing controller embedded data driver (TED).

The display panel 100 includes a display region configured to display images and a peripheral region adjacent to (e.g., in a periphery of) the display region. For example, the peripheral region may be called as a bezel.

The display panel 100 includes a plurality of gate lines GL, a plurality of data lines DL and a plurality of pixels electrically connected to the gate lines GL, and the data lines DL respectively. The gate lines GL may extend in a first direction D1, the data lines DL may extend in a second direction D2 crossing the first direction D1.

The driving controller 200 receives an input image data IMG and an input control signal CONT from an external device. For example, the input image data IMG may include red image data, green image data and blue image data. The input image data IMG may include white image data. The input image data IMG may include magenta image data, yellow image data and cyan image data. The input control signal CONT may include a master clock signal and a data enable signal. The input control signal CONT may further include a vertical synchronization signal and a horizontal synchronization signal.

The driving controller 200 generates a first control signal CONT1, a second control signal CONT2, a third control signal CONT3 and a data signal DATA based on the input image data IMG and the input control signal CONT.

The driving controller 200 generates the first control signal CONT1 for controlling an operation of the gate driver 300 based on the input control signal CONT and outputs the generated first control signal CONT1 to the gate driver 300. The first control signal CONT1 may include a start signal and a gate clock signal.

The driving controller 200 generates the second control signal CONT2 for controlling an operation of the data driver 500 based on the input control signal CONT and outputs the generated second control signal CONT2 to the data driver 500. The second control signal CONT2 may include a horizontal start signal and a load signal.

The driving controller 200 generates the data signal DATA based on the input image data IMG and outputs the data signal DATA to the data driver 500.

The driving controller 200 generates the third control signal CONT3 for controlling an operation of the gamma reference voltage generator 400 based on the input control signal CONT and outputs the generated third control signal CONT3 to the gamma reference voltage generator 400.

The gate driver 300 generates gate signals GW[n] for driving the gate lines GL in response to the first control signal CONT1 received from the driving controller 200. The gate driver 300 may output the gate signals GW[n] to the gate lines GL. For example, the gate driver 300 may output the gate signals GW[n] to the gate lines GL sequentially. For example, the gate driver 300 may be mounted on the peripheral region of the display panel 100. For example, the gate driver 300 may be integrated on the peripheral region of the display panel 100.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500.

For example, the gamma reference voltage generator 400 may be located in the driving controller 200, or in the data driver 500.

The data driver 500 receives the second control signal CONT2 and the data signal DATA from the driving controller 200 and receive the gamma reference voltage VGREF from the gamma reference voltage generator 400. The data driver 500 may convert the data signal DATA into an analog form of a data voltage VDATA by using the gamma reference voltage VGREF. The data driver 500 outputs the data voltage VDATA to the data line DL.

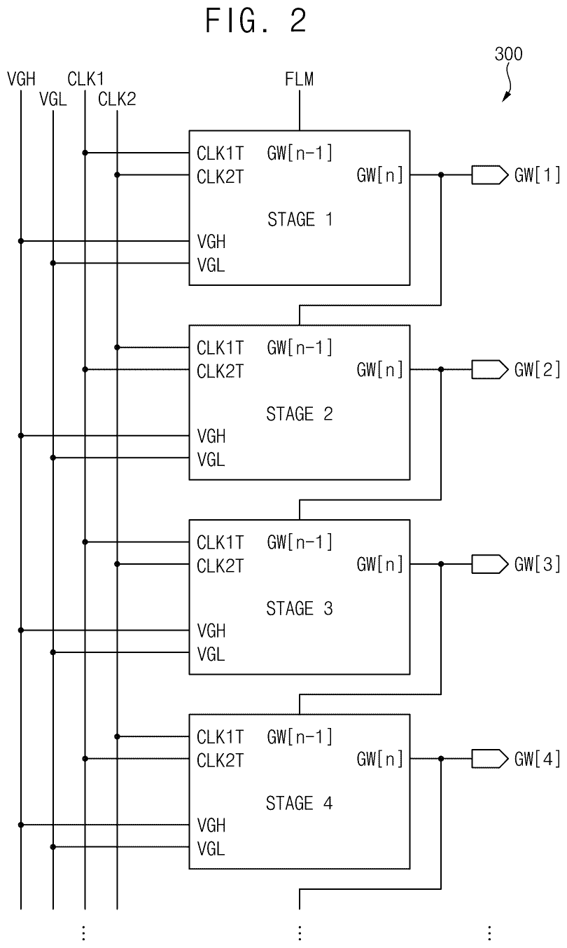

FIG. 2 is a block diagram illustrating a gate driver 300 included in display device of FIG. 1.

Referring to FIGS. 1 and 2, the gate driver 300 may include a plurality of stages STAGE 1, STAGE 2, STAGE 3, STAGE 4, . . . in which receives the start signal FLM, a first clock signal CLK1 and a second clock signal CLK2, and sequentially outputs the gate signals GW[1], GW[2], GW[3], GW[4], . . . to a plurality of pixels row by row.

The first clock signal CLK1 and the second clock signal CLK2 may apply to a first clock terminal CLK1T and a second clock terminal CLK2T of the first stage STAGE 1. The first clock signal CLK1 and the second clock signal CLK2 may apply to the second clock terminal CLK2T and the first clock terminal CLK1T of the second stage STAGE 2. Likewise, The first clock signal CLK1 and the second clock signal CLK2 may apply to the first clock terminal CLK1T and the second clock terminal CLK2T of the third stage STAGE 3. The first clock signal CLK1 and the second clock signal CLK2 may apply to the second clock terminal CLK2T and the first clock terminal CLK1T of the fourth stage STAGE 4.

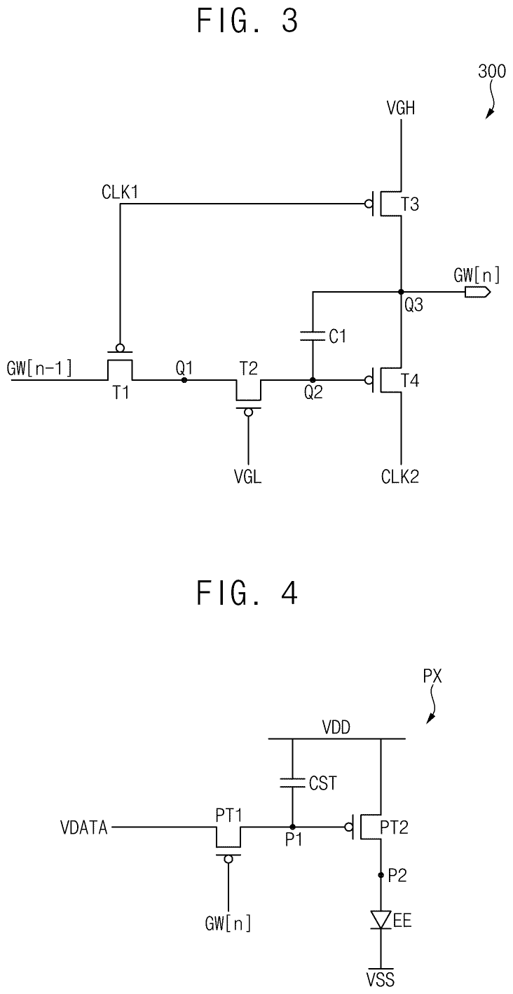

FIG. 3 is a circuit diagram illustrating a gate driver 300 of FIG. 2 according to some embodiments. Although FIG. 3 illustrates various components of a gate driver 300 according to some embodiments, embodiments according to the present disclosure are not limited thereto, and according to some embodiments, the gate driver 300 may include additional components or fewer components without departing from the spirit and scope of embodiments according to the present disclosure.

Referring to FIG. 3, the gate driver 300 may include a first transistor T1, a second transistor T2, a third transistor T3, a fourth transistor T4 and a first capacitor C1. The gate driver may be 4T1C structure including four transistors and one capacitor. For example, a transistor may include a control electrode (e.g. gate electrode), a first electrode (e.g. one of a source electrode and a drain electrode) and a second electrode (e.g. one of a source electrode and a drain electrode).

According to some embodiments, the first transistor may include a control electrode configured to receive the first clock signal CLK1, a first electrode configured to receive a previous stage gate signal GW[n−1] and a second electrode connected to a first node Q1. The first transistor T1 may apply the previous stage gate signal GW[n−1] to the first node Q1 in response to the first clock signal CLK1. For example, the first clock signal CLK1 and the second clock signal CLK2 may be toggled between a high voltage and a low voltage. For example, the first clock signal CLK1 and the second clock signal CLK2 may be toggled between a first power voltage VGH and a second power voltage VGL. For example, the first power voltage VGH may be the high voltage. For example, the second power voltage VGL may be the low voltage. For example, the high level may be about 6V. However, embodiments according to the present disclosure are not limited to a value of the high voltage. The second power voltage VGL may be the low voltage. The second power voltage VGL may be lower than the first power voltage VGH. For example, the low voltage may be about −6V. However, embodiments according to the present disclosure are not limited to a value of the low voltage.

According to some embodiments, a channel length (L) of the first transistor T1 may be longer than a channel length of the second transistor T2. Accordingly, a stability and a reliability of the gate driver 300 may be relatively more improved.

According to some embodiments, the second transistor T2 may include a control electrode configured to receive the second power voltage VGL, a first electrode connected to the first node Q1 and a second electrode connected to a second node Q2. The second transistor T2 may apply a voltage of the first node Q1 to the second node Q2 in response to the second power voltage VGL.

According to some embodiments, the third transistor T3 may include a control electrode configured to receive the first clock signal CLK1, a first electrode configured to receive the first power voltage VGH and a second electrode connected to 1 a third node Q3. The third transistor T3 may apply the first power voltage VGH to the third node Q3 in response to the first clock signal CLK1.

According to some embodiments, the first clock signal CLK1 may be applied to the control electrode of the third transistor T3 directly. Accordingly, an integration of the gate driver 300 may be relatively improved compared to a gate driver of a conventional display device. Additionally, a bezel size of the display device according to the present disclosure may become relatively smaller.

According to some embodiments, a ratio (W/L) between a channel width (W) and a channel length of the third transistor T3 may be different from a ratio between a channel width and a channel length of the fourth transistor T4. For example, the channel width of the third transistor T3 may be shorter than the channel width of the fourth transistor T4. Accordingly, a size of the third transistor T3 may be decreased. The size of the third transistor T3 may be decreased, so that an integration of the gate driver 300 may be relatively improved. Accordingly, the bezel size of the display device according to the present disclosure may become even smaller.

According to some embodiments, the fourth transistor T4 may include a control electrode connected to the second node Q2, a first electrode configured to receive the second clock signal CLK2 and a second electrode connected to a third node Q3. The fourth transistor T4 may apply the second clock signal CLK2 to the third node Q3 in response to a voltage of the second node Q2. For example, a phase of the second clock signal CLK2 may be inverted from a phase of the first clock signal CLK1.

According to some embodiments, the first capacitor C1 may include a first electrode connected to the second node Q2 and a second electrode connected to the third node Q3. The first capacitor C1 may couple a change of a voltage of the third node Q3 and may apply the change of the voltage of the third node Q3 to the second node Q2. For example, a coupling operation of the first capacitor C1 may called as a 1 bootstrapping operation. A stability and a reliability of the gate driver 300 may be relatively improved through the coupling operation of the first capacitor C1.

According to some embodiments, the gate driver 300 may output a voltage of the third node Q3 as the gate signal GW[n]. For example, the gate signal GW[n] may have an activation level or an inactivation level.

FIG. 4 is a circuit diagram illustrating a pixel circuit PX included in a display device of FIG. 1. Although FIG. 4 illustrates various components of a pixel circuit PX according to some embodiments, embodiments according to the present disclosure are not limited thereto, and according to some embodiments, the pixel circuit PX may include additional components or fewer components without departing from the spirit and scope of embodiments according to the present disclosure.

Referring to FIG. 4, the pixel circuit PX may include a first pixel transistor PT1, a second pixel transistor PT2, a storage capacitor CST and a light emitting element EE. For example, the pixel circuit PX may have 2T1C structure. However, embodiments according to the present disclosure are not limited to a structure of the pixel circuit PX.

The first pixel transistor PT1 may include a control electrode configured to receive the gate signal GW[n], a first electrode configured to receive the data voltage VDATA and a second electrode connected to a first pixel node P1. The first pixel transistor PT1 may apply the data voltage VDATA to a control electrode of the second pixel transistor PT2 in response to the gate signal GW[n].

The second pixel transistor PT2 may include the control electrode connected to the first pixel node P1, a first electrode configured to receive a high power voltage VDD and a second electrode connected to a second pixel node P2. The second pixel transistor PT2 may output a driving current in response to a voltage of the first pixel node P1.

The storage capacitor CST may include a first electrode configured to receive the high power voltage VDD and a second electrode connected to the first pixel node P1. The storage capacitor CST may store the voltage of the first pixel node P1.

The light emitting element EE may include an anode connected to the second pixel node P2 and a cathode configured to receive a low power voltage VSS. The light emitting element EE may emit a light based on the driving current.

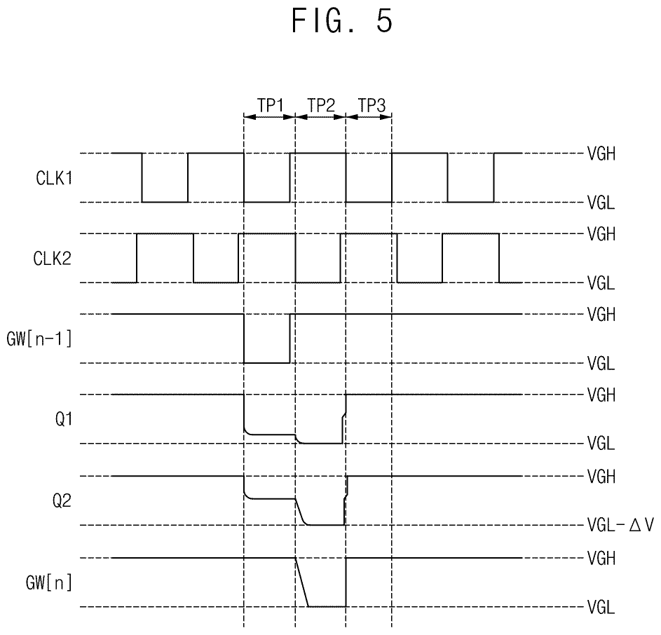

FIG. 5 is a timing diagram illustrating a gate driver of FIG. 2.

Referring to FIG. 5, according to some embodiments, a signal period applied to the gate driver 300 may include a first period TP1, a second period TP2 and a third period TP3.

According to some embodiments, in the first period TP1, the first clock signal CLK1 may have an activation level, the second clock signal CLK2 may have an inactivation level and the previous stage gate signal GW[n−1] may have an activation level. For example, the activation level may be the low voltage and the inactivation level may be the high voltage. For example, a voltage of the activation level may be about-6V and a voltage of the inactivation level may be about 6V. However, embodiments according to the present disclosure are not limited to the voltage of the activation level and the voltage of the inactivation level. For example, an activation level of an N-type transistor may be the high level and an inactivation level of an N-type transistor may be the low level.

According to some embodiments, in the second period TP2, the first clock signal CLK1 may have an activation level, the second clock signal CLK2 may have an inactivation level and the previous stage gate signal GW[n−1] may have an inactivation level.

According to some embodiments, in the third period TP3, the first clock signal CLK1 may have an activation level, the second clock signal CLK2 may have an 1 inactivation level and the previous stage gate signal GW[n−1] may have an inactivation level.

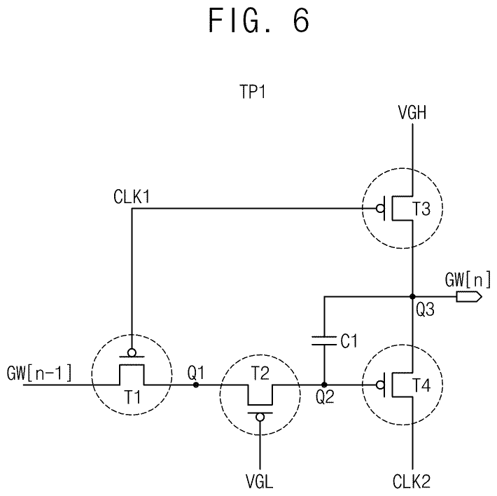

FIG. 6 is a circuit diagram illustrating an operation of a gate driver of FIG. 2 in a first period.

Referring to FIGS. 5 and 6, the first transistor T1 may be turned on in response to the first clock signal CLK1 having an activation level. Accordingly, the previous stage gate signal GW[n−1] having an activation level may apply to the first node Q1 and the second Q2. For example, a voltage of the first node Q1 may change to about-4V. In the first period TP1, the voltage of the first node Q1 may change from an inactivation level to an activation level. The third transistor T3 may be turned on in response to the voltage of the first node Q1. Accordingly, the second clock signal CLK2 may apply to the third node Q3. The third transistor T3 may apply the first power voltage VGH to the third node Q3 in response to the first clock signal CLK1 having an activation level. For example, the first power voltage may be about 6V and the voltage of the third node Q3 may be about 6V.

According to some embodiments, the gate driver 300 may output the gate signal GW[n] having an inactivation level in the first period TP1.

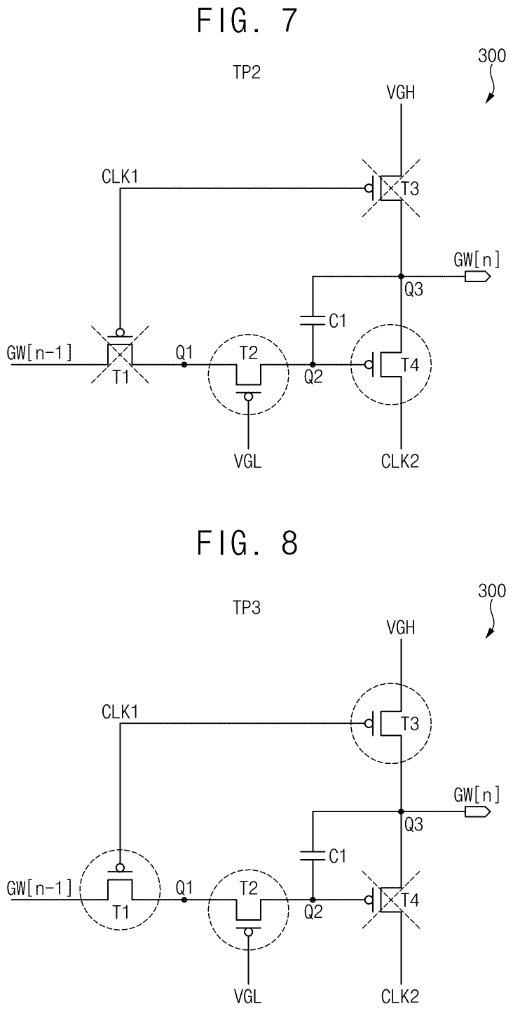

FIG. 7 is a circuit diagram illustrating an operation of a gate driver of FIG. 2 in a second period.

Referring to FIGS. 5 and 7, in the second period TP2, the first transistor T1 may be turned off in response to the first clock signal having an inactivation level. In the second period TP2, the first transistor T1 may be turned off, so that the second node Q2 may be a floating state. The third transistor T3 may be turned off in response to the first clock signal CLK1 having an inactivation level. The fourth transistor T4 may maintain a turned on state, the second clock signal CLK having an inactivation level may apply to the third node Q3. In the second period TP2, the voltage of the third node Q3 may change from an inactivation level (that is, the high voltage) to an 1 activation level (that is, the low voltage). The first capacitor C1 may couple the change of the third node Q3 and may apply to the second node Q2. For example, a voltage applied to the second node Q2 by coupling the change of the third node Q3 may be called as a bootstrapping voltage VGL-ΔV. For example, the voltage of the third node Q3 may change from about 6V to about −6V in the second period TP2 and the voltage of the second node Q2 may change from about −4V to about −16V. Accordingly, the fourth transistor T4 may apply the second clock signal CLK2 to the third node Q3 stably. Accordingly, a reliability and a stability of the gate driver 300 may be relatively improved. According to some embodiments, the gate driver 300 may output the gate signal GW[n] having an activation level.

According to some embodiments, an activation level period of the first clock signal CLK1 and the second clock signal CLK2 may be longer than an inactivation period of the first clock signal CLK1 and the second clock signal CLK2. Accordingly, a time for performing the coupling operation of the first capacitor C1 in the second section TP2 may be further secured.

FIG. 8 is a circuit diagram illustrating an operation of a gate driver of FIG. 2 in a third period.

Referring to FIGS. 5 and 8, in the third period TP3, the first transistor T1 may be turned on in response to the first clock signal CLK1 having an activation level. The first transistor T1 may apply the previous stage gate signal GW[n−1] having an inactivation level to the first node Q1. Accordingly, the previous stage gate signal GW[n−1] having an inactivation level may be applied to the second node Q2. Accordingly, the fourth transistor T4 may be turned off. In the third period TP3, the third transistor T3 may be turned on in response to the first clock signal having an activation level. Accordingly, the third transistor T3 may apply the first power voltage VGH to the third node Q3.

According to some embodiments, the gate driver 300 may output the gate signal GW[n] having an inactivation level in the third period TP3.

A gate driver of a conventional display device may include eight transistors and two capacitors. In contrast, the gate driver 300 of the display device according to some embodiments of the present disclosure may include four transistors and one capacitor. Accordingly, an integration of the gate driver 300 may be relatively improved, the bezel size of the display device may be reduced and a power consumption may be reduced. Additionally, the gate driver 300 according to some embodiments of the present disclosure are may have performance similar to the gate driver of the alternative display devices, despite having fewer transistors and fewer capacitors than the gate driver of the alternative display device. Accordingly, the gate driver 300 according to some embodiments of the present disclosure may reduce the bezel size without deteriorating performance.

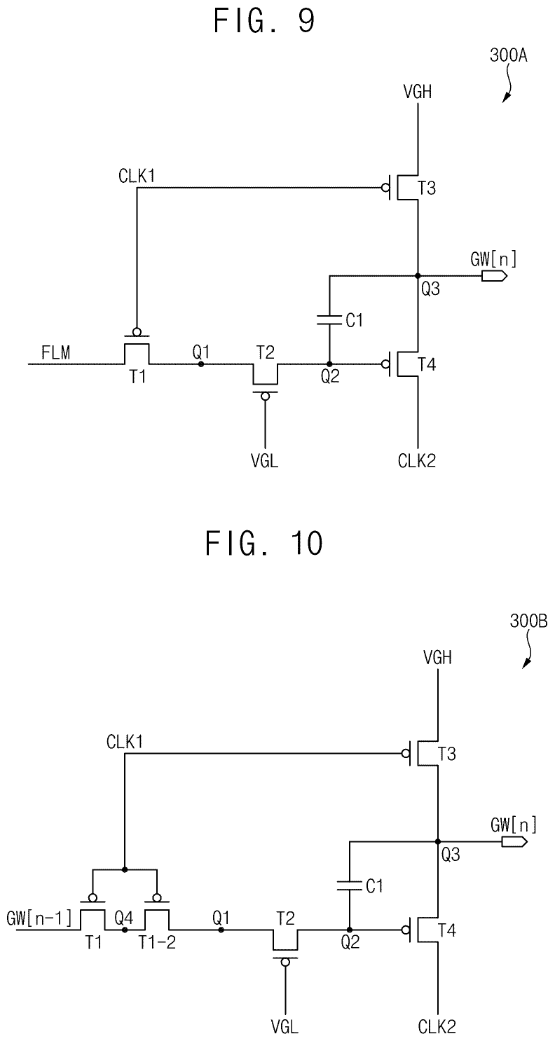

FIG. 9 is a circuit diagram illustrating a gate driver of FIG. 2 according to some embodiments.

Because a gate driver 300A according to FIG. 9 is substantially identical to the gate driver 300 of FIG. 2, except that the previous stage gate signal GW[n−1] is the start signal FLM. Thus, the same reference numerals will be used to refer to the same and any repetitive explanation concerning the above elements will be omitted.

Referring to FIGS. 2 and 9, according to some embodiments, the previous stage gate signal GW[n−1] of the gate driver 300A may be the start signal FLM. For example, the first stage STAGE 1 of the gate driver 300A may output the gate signal GW[n] in response to the start signal FLM. For example, the gate signal GW[n] of the first stage STAGE 1 may be a first gate signal GW[1].

FIG. 10 is a circuit diagram illustrating a gate driver of FIG. 2 according to some embodiments.

Because a gate driver 300B according to FIG. 10 is substantially identical to the gate driver 300 of FIG. 2, except that the gate driver 300B further includes the first transistor T1 and a first-second transistor T1-2 connected in series with the first transistor T1 and the second electrode of the first transistor T1 is connected to not the first node Q1 but the fourth node Q4 and the first-second transistor T1-2 includes a control electrode configured to receive the first clock signal CLK1, a first electrode connected to the fourth node Q4 and a second electrode connected to the first node Q1. Thus, the same reference numerals will be used to refer to the same and any repetitive explanation concerning the above elements will be omitted.

According to some embodiments, the gate driver 300B may include the first transistor T1, the first-second transistor T1-2, the second transistor T2, the third transistor T3, the fourth transistor T4 and the first capacitor C1. The gate driver 300B may have a 5T1C structure including five transistors and one capacitor. Accordingly, an integration of the gate driver 300B may be relatively improved, the bezel size of the display device may be reduced and a power consumption may be reduced. Additionally, the first transistor T1 and the first-second transistor T1-2 is connected in series, so that the voltage of the first node Q1 and the voltage of the second node Q2 may be maintained stably. Accordingly, a reliability and a stability of the gate driver 300B may be relatively improved.

Additionally, the gate driver 300B may have performance similar to the gate driver of the conventional display device, despite having fewer transistors and fewer capacitors than the gate driver of the conventional display device. Accordingly, the gate driver 300B may reduce the bezel size without deteriorating performance.

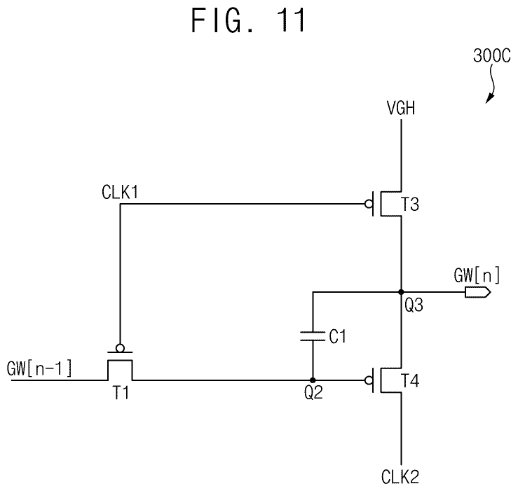

FIG. 11 is a circuit diagram illustrating a gate driver of FIG. 2 according to some embodiments.

Because a gate driver 300C according to FIG. 11 is substantially identical to the gate driver 300 of FIG. 2, except that, the second electrode of the first transistor T1 is connected to the second node Q2. Thus, the same reference numerals will be used to refer to the same and any repetitive explanation concerning the above elements will be omitted.

The gate driver 300C may include the first transistor T1, the third transistor T3, the fourth transistor T4 and the first capacitor C1. For example, the gate driver 300C may have 3T1C structure.

The gate driver 300C may have performance similar to the gate driver of the conventional display device, despite having fewer transistors and fewer capacitors than the gate driver of the conventional display device. Accordingly, the gate driver 300B may reduce the bezel size without deteriorating performance.

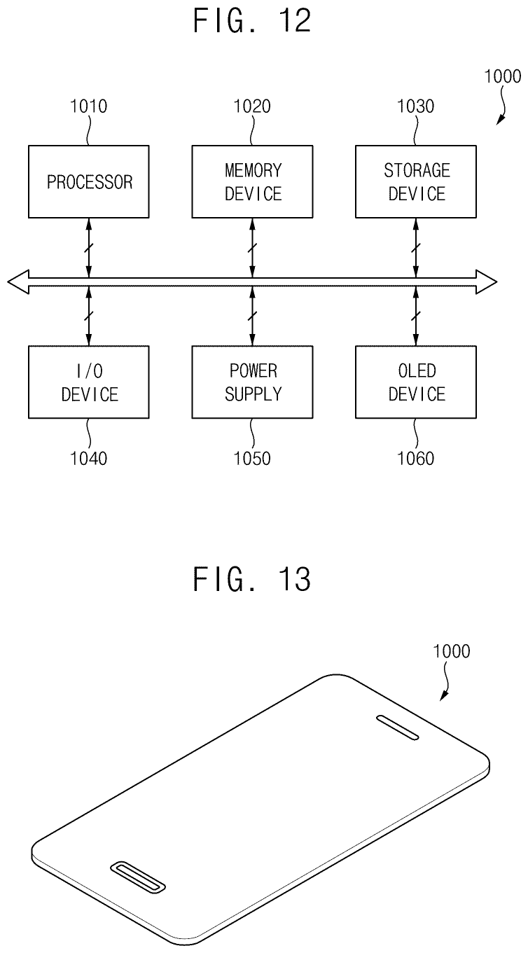

FIG. 12 is a block diagram illustrating an electronic device according to some embodiments of the present disclosure. FIG. 13 is a diagram illustrating an example in which the electronic device of FIG. 11 is implemented as a smart phone. Referring to FIGS. 12 and 13, the electronic device 1000 may include a

processor 1010, a memory device 1020, a storage device 1030, an input/output (I/O) device 1040, a power supply 1050 and a display device 1060. Here, the display device 1060 may be the display device of FIG. 1. In addition, the electronic device 1000 may further include a plurality of ports for communicating with a video card, a sound card, a memory card, a universal serial bus (USB) device, other electronic devices, etc.

According to some embodiments, as shown in FIG. 13, the electronic device 1000 may be implemented as a smart phone. However, the electronic device 1000 is not limited thereto. For example, the electronic device 1000 may be implemented as a cellular phone, a video phone, a smart pad, a smart watch, a tablet PC, a car navigation system, a computer monitor, a laptop, a head mounted display (HMD) device and the like.

The processor 1010 may perform various computing functions or various tasks. The processor 1010 may be a micro-processor, a central processing unit (CPU), an application processor (AP) and the like. The processor 1010 may be coupled to other components via an address bus, a control bus, a data bus, etc. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic device 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device and the like and/or at least one volatile memory device such as a dynamic random access memory (DRAM) device, a static random access memory (SRAM) device, a mobile DRAM device and the like.

The storage device 1030 may include a solid state drive (SSD) device, a hard disk drive (HDD) device, a CD-ROM device and the like. The I/O device 1040 may include an input device such as a keyboard, a keypad, a mouse device, a touch-pad, a touch-screen and the like and an output device such as a printer, a speaker and the like. In some embodiments, the display device 1060 may be included in the I/O device 1040. The power supply 1050 may provide power for operations of the electronic device 1000. The display device 1060 may be coupled to other components via the buses or other communication links.

According to the gate driver and the display device described above, the display device in which an integration of the display device is relatively improved and a bezel size of the display device become relatively smaller by including a smaller number of transistors and a smaller number of capacitors may be provided.

The foregoing is illustrative of aspects of some embodiments of the present disclosure and is not to be construed as limiting thereof. Although a few embodiments of the present disclosure have been described, those skilled in the art will readily appreciate that many modifications are possible in the embodiments without materially departing from the novel teachings and characteristics of embodiments according to the present disclosure. Accordingly, all such modifications are intended to be included within the spirit and scope of embodiments according to the present disclosure as defined in the claims, and their equivalents. In the claims, means-plus-function clauses are intended to cover the structures described herein as performing the recited function and not only structural equivalents but also equivalent structures. Therefore, it is to be understood that the foregoing is illustrative of embodiments according to the present disclosure and is not to be construed as limited to the specific embodiments disclosed and that modifications to the disclosed embodiments, as well as other embodiments, are intended to be included within the scope of the appended claims. The present disclosure is defined by the following claims, with equivalents of the claims to be included therein.

What is claimed is:

1. A gate driver comprising a plurality of stages, at least one stage of the plurality of stages comprising:
a first transistor including a control electrode configured to receive a first clock signal, a first electrode configured to receive a previous stage gate signal, and a second electrode connected to a first node;
a third transistor including a control electrode configured to directly receive the first clock signal, a first electrode configured to receive a first power voltage, and a second electrode connected to a third node;
a fourth transistor including a control electrode connected to a second node, a first electrode configured to receive a second clock signal different from the first clock signal, and a second electrode connected to the third node; and
a first capacitor including a first electrode connected to the second node and a second electrode connected to the third node,
wherein the least one stage is configured to output a voltage of the third node as a gate signal.

2. The gate driver of claim 1, wherein the least one stage further comprises:
a second transistor including a control electrode configured to receive a second power voltage different from the first power voltage, a first electrode connected to the first node, and a second electrode connected to the second node.

3. The gate driver of claim 1, wherein a ratio of a channel width to a channel length of the third transistor is different from a ratio of a channel width to a channel length of the fourth transistor.

4. The gate driver of claim 1, wherein a channel width of the third transistor is narrower than a channel width of the fourth transistor.

5. The gate driver of claim 1, wherein the fourth transistor is configured to be turned on based on the previous stage gate signal having an activation level in a first period.

6. The gate driver of claim 5, wherein, in a second period subsequent to the first period, the first clock signal has an inactivation level, the second clock signal has an activation level and a voltage of the second node is lower than a low voltage of the second clock signal.

7. The gate driver of claim 6, wherein, in a third period subsequent to the second period, the first clock signal has an activation level, the second clock signal has an inactivation level and the gate signal has an inactivation level.

8. The gate driver of claim 1, wherein the least one stage further comprises a second transistor including a control electrode configured to receive a second power voltage different from the first power voltage, a first electrode connected to the first node, and a second electrode connected to the second node, and
wherein a channel length of the first transistor is longer than a channel length of the second transistor.

9. The gate driver of claim 1, wherein an activation level period of the first clock signal is longer than an inactivation level period of the first clock signal, and
wherein a phase of the second clock signal is opposite to a phase of the first clock signal.

10. The gate driver of claim 1, wherein the least one stage further comprises a first-second transistor connected in series with the first transistor, and
wherein the first-second transistor includes a control electrode configured to receive the first clock signal, a first electrode connected to a fourth node and a second electrode connected to the first node.

11. A gate driver comprising a plurality of stages, at least one stage of the plurality of stages comprising:
a first transistor configured to apply a previous stage gate signal to a first node in response to a first clock signal;
a second transistor connected between the first node and a second node;
a third transistor configured to directly receive the first clock signal and configured to apply a first power voltage to a third node;
a fourth transistor configured to apply a second clock signal different from the first clock signal to the third node in response to a voltage of the second node; and
a first capacitor connected between the second node and the third node,
wherein the least one stage is configured to output a voltage of the third node as a gate signal.

12. The gate driver of claim 11, wherein a ratio of a channel width to a channel length of the third transistor is different from a ratio of a channel width to a channel length of the fourth transistor.

13. The gate driver of claim 12, wherein a channel width of the third transistor is narrower than a channel width of the fourth transistor.

14. A display device comprising:
a display panel;
a gate driver configured to output a gate signal to a gate line of the display panel; and
a data driver configured to output a data voltage to a data line of the display panel,
wherein the gate driver comprises a plurality of stages,
wherein at least one stage of the plurality of stages comprises:
a first transistor including a control electrode configured to receive a first clock signal, a first electrode configured to receive start signal and a second electrode connected to a first node;
a second transistor including a control electrode configured to receive a second power voltage, a first electrode connected to the first node and a second electrode connected to a second node;
a third transistor including a control electrode configured to receive the first clock signal directly, a first electrode configured to receive a first power voltage different from the second power voltage and a second electrode connected to a third node;
a fourth transistor including a control electrode connected to the second node, a first electrode configured to receive a second clock signal different from the first clock signal and a second electrode connected to the third node; and
a first capacitor including a first electrode connected to the second node and a second electrode connected to the third node, and
wherein the least one stage is configured to output a voltage of the third node as the gate signal.

15. The display device of claim 14, wherein a ratio of a channel width to a channel length of the third transistor is different from a ratio of a channel width to a channel length of the fourth transistor.

16. The display device of claim 14, wherein a channel width of the third transistor is narrower than a channel width of the fourth transistor.

17. The display device of claim 14, the fourth transistor is turned on based on the start signal having an activation level in a first period.

18. The display device of claim 17, in a second period subsequent to the first period, the first clock signal has an inactivation level, the second clock signal has activation level, and a voltage of the second node is lower than the second power voltage.

19. The display device of claim 18, in a third period subsequent to the second period, the first clock signal has an activation level, the second clock signal has an inactivation level and the gate signal has an inactivation level.

20. The display device of claim 14, wherein an activation level period of the first clock signal is longer than an inactivation level period of the first clock signal, and
wherein the second clock signal has an inverted phase from the first clock signal.
